(19) United States
(12) Patent Application Publication
(10) Pub. No.: US 2013/0110345 A1
(43) Pub. Date: May 2, 2013

(54) ELECTRONIC DISTANCE RECORDER VERIFICATION

(71) Applicant: Bruce John Wilson, Ellerslie (NZ)

(72) Inventor: Bruce John Wilson, Ellerslie (NZ)

(21) Appl. No.: 13/521,612

(22) PCT Filed: Dec. 15, 2010
(86) PCT No.: PCT/NZ2010/000255

§ 371 Date: Oct. 15, 2012

(30) Foreign Application Priority Data
Jan. 14, 2010 (NZ) 582630

(51) Int. Cl. G01C 22/00

(52) U.S. Cl. CPC G01C 22/00
USPC 701/31.4; 701/32.5

(57) ABSTRACT

A method is provided for checking a vehicle's electronic distance recorder by an independent party, including the independent party using one or more devices for: obtaining or receive two distance or location readings, or a distance and location reading, from the electronic distance recorder for two vehicle locations, the distance location/readings being obtained by the electronic distance recorder, determining an apparent distance travelled between the two vehicle locations using the distance/location readings; and comparing the apparent distance travelled with a verification distance between the two locations to identify any discrepancies in the electronic distance recorder, the verification distance being determined independently from the electronic distance recorder.

### FIELD OF THE INVENTION

The present invention relates to remote interrogation of electronic odometers in order to verify their accuracy.

### BACKGROUND OF THE INVENTION

In some countries vehicles pay road user charges to a government authority to maintain roads. Road user charges may be based on distance travelled. A distance recorder is used for this purpose. That is, the distance recorder tracks the distance travelled by a vehicle thus enabling road user charges to be levied. Time, location and/or weight can also be used to levy road user charges.

Traditionally, mechanical distance recorders are used, although more recently electronic distance recorders are used. Electronic distance recorders are not necessarily mounted on the wheel of a vehicle as is a traditional mechanical hubodometer. The difficulty with distance recorders is that inaccuracies or tampering can occur, which may result in the inaccurate levying of fees.

### SUMMARY OF INVENTION

It is the object of the present invention to provide for verification of distance readings determined by an electronic distance recorder.

A method of checking a vehicle's electronic distance recorder comprising: obtaining/receiving two distance or location readings (or a distance and location reading) from the electronic distance recorder for two vehicle locations, determining an apparent distance travelled between the two vehicle locations, and comparing the apparent distance travelled with a verification distance between the two locations to identify any discrepancies in the electronic distance recorder.

Preferably the method further comprises obtaining one or more images of the vehicle.

Preferably the method further comprises obtaining/receiving a time reading.

Preferably the method further comprises comparing the time and/or location reading(s) to a reference to identify discrepancies.

A system for checking a vehicle's electronic distance recorder comprising an interrogation apparatus configured to: obtain/receive two distance or location readings (or a distance and location reading) from the electronic distance recorder for two vehicle locations, determine an apparent distance travelled between the two vehicle locations, and compare the apparent distance travelled with a verification distance between the two locations to identify any discrepancies in the electronic distance recorder.

A system for checking a vehicle's electronic distance recorder comprising an interrogation apparatus configured to: remotely obtain/receive two distance or location readings (or a distance and location reading) from the electronic distance recorder for two vehicle locations, and transmit the information to a processor to determine an apparent distance travelled between the two vehicle locations, and compare the apparent distance travelled with a verification distance between the two locations to identify any discrepancies in the electronic distance recorder.

In one embodiment, the system comprises two or more interrogation devices that form the interrogation apparatus. In another embodiment, there is only one interrogation device forming the apparatus. Preferably the system further comprises an electronic distance recorder in a vehicle. Optionally, the system comprises a proximate or remote server or computer system in communication with the interrogation device(s). Optionally, the interrogation devices are in communication with each other. Optionally the computer system or server form part or all of the interrogation apparatus and is proximate or remote to the locations. Alternatively, the interrogation device comprises a data capture device and a remote processor (optionally in a computer system or server), wherein the data capture device transmits captured data to the remote processor. The interrogation device and remote processor form the interrogation apparatus.

A system for checking a vehicle's distance recorder comprising an interrogation apparatus configured to: remotely obtain two distance readings from the electronic distance recorder for two vehicle locations, and transmit the information to a processor to determine an apparent distance travelled between the two vehicle locations, and compare the apparent distance travelled with a verification distance between the two locations to identify any discrepancies in the electronic distance recorder.

An interrogation apparatus for checking a vehicle's electronic distance recorder configured to: obtain/receive two distance or location readings (or a distance and location reading) from the electronic distance recorder for two vehicle locations, determine an apparent distance travelled between the two vehicle locations, and compare the apparent distance travelled with a verification distance between the two locations to identify any discrepancies in the electronic distance recorder.

An interrogation apparatus for checking a vehicle's electronic distance recorder configured to: obtain/receive two distance or location readings (or a distance and location reading) from the electronic distance recorder for two vehicle locations, and transmit the information to a processor to determine an apparent distance travelled between the two vehicle locations, and compare the apparent distance travelled with a verification distance between the two locations to identify any discrepancies in the electronic distance recorder.

Preferably, each distance or location reading is obtained by interrogating the electronic distance recorder at the respective vehicle location. Alternatively, each distance or location reading is obtained remotely by interrogating the electronic distance recorder at one or neither of the locations. Remote interrogation can be achieved through a cellular network, or short range radio or optical network, using RF, Bluetooth, IR and/or DSRC for example.

One or both of the distance or location readings can be obtained at the time the vehicle is at the respective location, or one or both of the distance or location readings can be obtained retrospectively at a time when the vehicle is not at the respective location.

Preferably, the distance or location readings are derived from output from an internal odometer, speed signal, GPS and/or accelerometer/gyroscope.

The verification distance can be obtained from parameter readings obtained from the electronic distance recorder corresponding to the two vehicle locations. Alternatively, the verification distance can be determined using an external measure.

Preferably, the electronic distance recorder is interrogated at the respective vehicle location using an interrogation apparatus. More preferably the interrogation apparatus is proximate the vehicle location. More preferably, the interrogation apparatus is stationed proximate the vehicle location. Alternatively, the interrogation apparatus is transported to a position proximate the vehicle location.

Alternatively, the interrogation apparatus is stationed or transported to a location remote to the first and/or second locations.

Preferably the interrogation apparatus comprises an image capture device for capturing an image of the vehicle and/or licence/registration plate for use with ALPR (automatic licence plate recognition) technology.

A method of checking a vehicle's electronic distance recorder comprising: obtaining/receiving at least one location reading from the electronic distance recorder obtained when the vehicle was a reference distance away from a first vehicle location, comparing the location reading with a known location of a point being the reference distance away from the first vehicle location to identify any discrepancies in the electronic distance recorder.

A method of checking a vehicle's electronic distance recorder comprising: obtaining/receiving, an odometer reading for first and second vehicle locations, determining the distance travelled between the first and second locations based on the odometer readings, and comparing the distance travelled to a verified distance between the first and second locations to identify any discrepancies in the electronic distance recorder.

A system for checking a vehicle's electronic distance recorder comprising one or more interrogation apparatus configured to: obtain/receive odometer readings for first and second vehicle locations, determine the distance travelled between the first and second locations based on the odometer readings, and compare the distance travelled to a verified distance between the first and second locations to identify any discrepancies in the electronic distance recorder.

### BRIEF DESCRIPTION OF THE DRAWINGS

Preferred embodiments of the invention will be described with reference to the drawings of which:

FIG. 1 shows in diagrammatic form the interrogation of a vehicle's electronic distance recorder as it passes through two locations,

FIG. 2 shows in diagrammatic form the electronic distance recorder and interrogation apparatus in further detail, and

FIG. 3 shows a flow diagram of a method for operating the system.

### DETAILED DESCRIPTION OF PREFERRED EMBODIMENTS

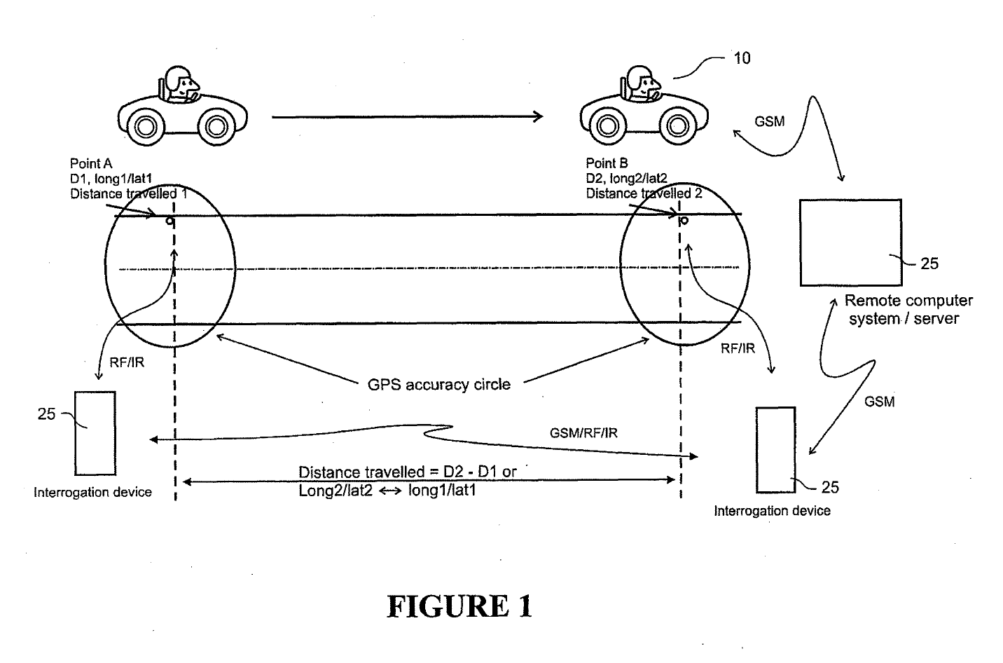

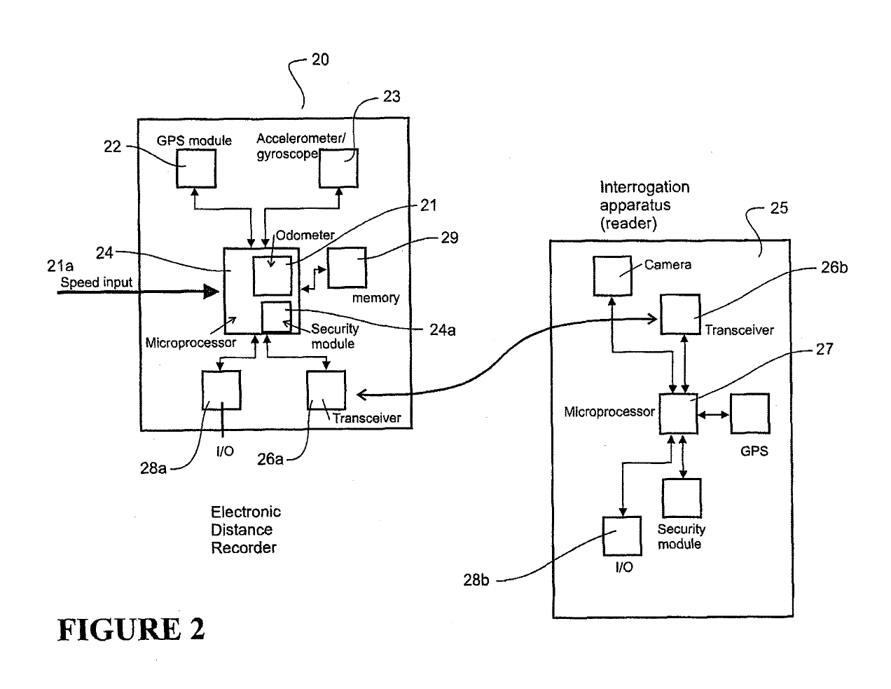

FIG. 1 shows in schematic form a vehicle 10 with an electronic distance recorder 11 (see FIG. 2) that is utilised for determining distance travelled for levying road user charges. The electronic distance recorder 11 can be interrogated by interrogating apparatus stationed at or transported to a position road side or remotely. The interrogation apparatus can obtain various readings from the electronic distance recorder and from this determine (using a distance verification algorithm) whether the readings are accurate, or inaccurate due to tampering or malfunction. The interrogation apparatus forms an interrogation system, optionally along with various other apparatus. The distance recorder in the vehicle might be considered to be part of the interrogation system, although can be considered separate to the system also.

Various architectures for the system are possible. In one embodiment, the interrogation apparatus takes the form of an interrogation device. This can reside at or be moved to a road side, or remote, location and can be fixed or portable. It obtains the required information from the distance recorder, and carries out verification. It may also communicate with a central system to provide results or to conduct further processing. Alternatively, two such devices might be used, either fixed or portable, and generally proximate the first and second locations (A, B) respectively. Each device can obtain the required information from the distance recorder and conduct verification. The two devices might communicate with each other to transfer information to assist verification. Both devices might communicate with a central system to provide results or conduct further processing.

In another embodiment, the interrogation apparatus is a computer system or server (usually remotely positioned, although this is not essential), that obtains the required information directly from the distance recorder over a network, such as a cellular telephone network. It then conducts verification. In this embodiment, the computer system/server comprises or couples to data capture apparatus that might be similar in function to the interrogation device. The data capture apparatus forms part of the server/computer or is stationed near it.

In another embodiment, one or more interrogation devices obtain the required information and transmit the information to a central server or computer system to conduct verification. In this case, the interrogation devices could be “dumb” data capture devices. Here, the interrogation apparatus could be the combination of the interrogation devices and the computer system/server, or the solely the computer system/server.

Other alternatives are possible also.

FIG. 2 shows the interaction between the electronic distance recorder and interrogation apparatus. The electronic distance recorder 20 contains various modules for determining position (location), speed and/or distance travelled. It comprises an odometer 21, that measures distance travelled, a GPS module 22 that obtains position (e.g. in the form of longitude and latitude), altitude, distance travelled and/or speed data, and an accelerometer and/or gyroscope (dead reckoning module) 23 from which speed, position and/or distance travelled data can be determined. Other modules might also be provided. Position and location can be considered interchangeable terms. The term GPS is used in the more generic manner to encompass any type of Global Navigation Satellite System (GNSS).

These are all coupled to or implemented in a microprocessor 24 that can receive input from the odometer, GPS, accelerometer (and any other) modules, other external sources (such as the vehicle), and determine a position, speed and/or distance travelled by the vehicle. For example, the odometer 21 is implemented in the microprocessor 24, and the microprocessor determines odometer readings based on speed (rotation) data received via an input 21a from the vehicle. The GPS and accelerometer/gyroscope modules obtain information from which speed, position, distance travelled, and longitude/latitude, can be determined, either internally or by the microprocessor. This information can be displayed on an input/output interface 28a, and/or stored in a memory or other storage device.

The electronic distance recorder 20 also comprises a transceiver 26a (which might comprise a GSM module), which can receive interrogation signals and in response send data signals containing data comprising data on parameters stored in the memory 29. Alternatively, it might not require an interrogation signal, and instead broadcast data periodically for receipt by the interrogation apparatus, unprompted. Such a broadcast might be done in real time as data is collected, or retrospectively, either in individual transmissions for each reading, or alternatively in a single transmission containing all relevant readings. A security module 24a is also coupled to the microprocessor to ensure privacy, integrity and authenticity of data being obtained from the distance recorder and transmitted onwards. The distance recorder also has a clock, which could be implemented in the microprocessor.

The odometer 21 works in the following manner. As the vehicle travels, the odometer 21 obtains data/signals on inputs/sensors from the drive shaft and/or wheels, to which it (or the microprocessor 24) is coupled, for providing a speed or odometer signal from a digital tachograph or CAN bus signal or GPS signal. From this, a distance travelled (distance parameter) since the odometer 21 was initialised (e.g. upon initial connection to vehicle) can be determined (for example, internally by the odometer 21 or by the microprocessor 24.) The data/signals can be obtained from the inputs periodically and stored in the memory 29, along with the distance travelled determined from those inputs. The distance travelled can be displayed on the input/output interface 28a. The distance travelled can be referred to as “distance”.

GPS data/signals are periodically obtained and stored by the GPS module 22 from a GPS satellite system, thus obtaining location information (such as longitude and latitude) of the vehicle at the particular reading times. From this, speed (speed parameter), position (position parameter) and/or distance travelled (distance parameter) since initialisation can be determined (for example, internally by the GPS module 21 or by the microprocessor 24.) The data/signals can be obtained periodically and stored in the memory 29, along with the speed, position and/or distance travelled determined from the data/signals. The speed, position and/or distance travelled can be displayed on the input/output interface 29.

The accelerometer/gyroscope (dead reckoning device/module) 23 can determine speed, position and/or distance travelled since initialisation, or provide output to the microprocessor 24 to determine those parameters. The accelerometer measures low to high frequency vibrations in three axis acceleration. A distance calibration algorithm can use one or more or a combination of these to produce a distance travelled reading. The data/signals can be obtained periodically and stored in the memory 29, along with the speed, position and/or distance travelled determined from the data/signals. The speed, position and/or distance travelled can be displayed on the input/output interface 28a.

Similarly, speed, position and/or distance travelled can be determined from/by other modules and/or the microprocessor. The modules provide different sources for determining position, speed and distance travelled by the vehicle, which can be used for levying fees and or cross-checking/validation of the electronic distance recorder's outputs. All data/signals and determined parameters obtained and stored are also preferably cross-referenced to each other. Therefore, a distance parameter determined by or form the odometer module 21 taken at a particular time can be stored and cross referenced to a corresponding parameter(s) (such as speed, position and/or distance travelled) determined by the GPS and/or accelerometer/gyroscope modules. Therefore, for example, the electronic distance recorder will contain stored data on speed, position and distance travelled parameters for the vehicle and particular times (and corresponding positions) determined by different sources at periodic (or continuous) times.

Typically, it is the distance travelled as determined by/from the odometer 21 that provides the reading for the electronic distance recorder, from which road user charges are levied. The other modules provide readings for cross-referencing and other purposes. However, this is not essential. The distance travelled parameter could be determined by any of the other modules as used as the primary means for determining distance for levying road user charges.

The interrogation apparatus 25 comprises a transceiver 26b (which might comprise a GSM module) that can send interrogation signals to the electronic distance recorder 20 and receive signals/data in response—or it might just receive such signals/data unprompted. The interrogation signals are triggered by a microprocessor 27 and the received data contains parameter data from the memory 29 of the electronic distance recorder 20. The received signals/data are passed from the transceiver to the microprocessor 27. The microprocessor can process the received data using an algorithm to determine if the speed, position and/or distance travelled are accurate. If the data is not correct, an indication can be provided on the input/output interface for 28b for the user. This could comprise a screen, LEDs, keypad, touchscreen, buttons or the like. The apparatus/reader shown in FIG. 2 might be a small handheld device or could be coupled or form part of a server or computer system, as described earlier. In that case, the microprocessor might be part of that computer system, or could be a separate dedicated'microprocessor. Those skilled in the art will understand there are various configurations possible. The apparatus also has a GPS module and security module and optionally a camera.

The transceiver in the distance recorder might comprise two transceivers—one (e.g. RF, IR, DSCR, Bluetooth) for communication with an interrogation device over a short/medium distance, and one (e.g. GSM module) for communicating to a remote server/computer, (e.g. over a cellular network). The interrogation apparatus (i.e. interrogation device/server/computer) would have corresponding transceivers as required. The term transceiver is therefore used generally to cover any transceiver(s) arrangement required to effect the required communication.

Referring to FIG. 1, in general terms, the invention operates in the following manner. A vehicle with an electronic distance recorder passes through two positions, e.g. point A and point B while travelling. The interrogation apparatus 25 (optionally) interrogates the electronic distance recorder and obtains the parameter(s) (e.g. distance, speed, position and/or distance travelled (odometer reading)) determined by the electronic distance recorder corresponding to the position/time when the vehicle was at a first location (e.g. point A), and a second location (e.g. point B). These parameters are those obtained by or from one or more of the modules 21-23. A comparison is then undertaken between the parameters obtained from one of the modules corresponding to the vehicle when it was at point A and B to determine a change in speed, distance travelled and/or position between the two points. This can be correlated to other parameters obtained from the other modules and/or external sources to determine if there is a discrepancy between the change in the parameter(s) from point A to point B

In a preferred embodiment, the invention is looking at the distance travelled between points A and B as determined by/from the odometer 21 (although alternatively it could look at this parameter as determined by/from other modules). The distance travelled is then compared to distance travelled between the two points as determined by/from the other modules (e.g. GPS and/or accelerometer modules) and/or as determined via an external calibrated means. Any discrepancy in the distance travelled between points A and B as determined by/from the odometer module can then be determined.

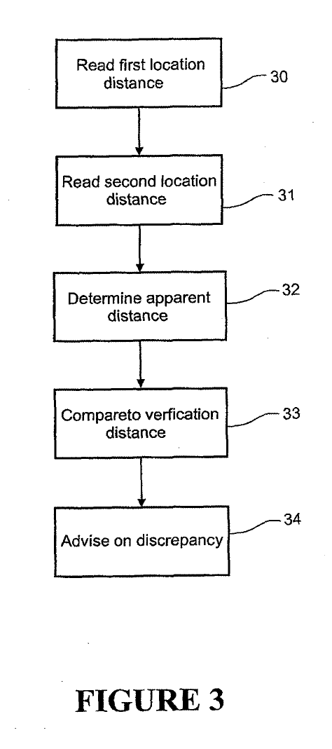

The preferred embodiment operates in the following manner as described in relation to FIGS. 1 and 3. The vehicle passes between points A and B, while travelling. The interrogation apparatus takes a first distance travelled reading (i.e. odometer reading) from the electronic distance recorder, as determined by/from the odometer 21 corresponding to when the vehicle was passing through point A, step 30. The interrogation apparatus also takes a second distance travelled reading (odometer reading) from the distance recorder, as determined by/from the odometer module corresponding to when the vehicle was passing through point B, step 31. Optionally, the interrogation device will also take speed, distance travelled, and/or position parameter (verification) readings as determined by/from one of the other modules. If taken, these readings will be obtained for when the vehicle was passing through points A and B.

The distance travelled readings (and if taken, the other verification readings) may be taken simultaneously or sequentially. They can be taken at the time the vehicle reaches/passes the respective locations (points A, B), or some time afterwards. For example, both readings for points A and B might be taken as the vehicle passes the second location, point B, or even later, after the vehicle has passed both points A, B. Each reading can be taken by the interrogation device when proximate to the respective location, or at another location entirely. For example, both readings might be taken from the same location, either at point A, point B or some other location.

Once the parameter readings are taken, the interrogation device determines the apparent distance travelled by the vehicle between the points A and B as determined from the distance travelled readings obtained corresponding to points A and B, step 32. For example, the distance travelled reading (odometer reading) taken for point A is subtracted from the distance travelled reading (odometer reading) taken for point B to arrive at the apparent distance travelled. This apparent distance travelled is then compared to a second (verification) distance reading, corresponding to the distance between point A and point B as determined from another source, step 33. This verification distance can be determined from the verification readings taken from the other modules and/or from an independent external measure of the distance between points A and B. If there is a discrepancy between the apparent distance travelled and verification distance, an indication of this discrepancy is provided, step 34.

In the above embodiment, a distance travelled reading (odometer reading) is taken. Alternatively, a position (location) reading could be taken, and apparent distance travelled determined from that.

In addition, information enabling the interrogation apparatus to verify the time and/or location (position) of the distance recorder might also be obtained and verified, similar to steps 31-33. In addition to distance travelled, road user charges might also levied based on time of day (e.g. peak travel times cost more) and actual location (e.g. inner city roads cost more than rural roads). Where road user charges use time and position as well, it is useful to verify these to ensure all charges a levied accurately.

One possible form of the preferred embodiment will be described in more detail with reference to FIGS. 1 and 3. Points A and B are identified on a road. The verification distance between point A and B is determined independently of the electronic distance recorder by an enforcement agent (such as traffic police) by measuring the distance using a calibrated distance recorder, GPS module, map data, road data, or other measuring means for measuring the distance between the two points. The verification distance can be determined, for example, by actually measuring the distance (such as 10 km) between the two points, or determining the distance the longitude and latitude of point B from that of point A using GPS coordinates, and from that determining the distance between the two points. This can be done prior to, during or after interrogation of the electronic distance recorder.

The enforcement agent then obtains two electronic distance recorder distance travelled readings of the vehicle corresponding to the distance travelled readings when the vehicle is at point A and when the vehicle is at point B, steps 30, 31, these being the readings determined by/from the internal odometer 21. The enforcement agent can obtain this internal odometer reading by interrogating the electronic distance recorder as the vehicle is passing point A and then subsequently interrogating the electronic distance recorder when the vehicle passes point B. The reading can be taken by physically having the interrogator in proximity of points A and B as the readings are being made, or alternatively having a reader that can operate at long distance and taking the readings at the two points in time from a single (or two) remote location(s).

Once the interrogation has taken place, the interrogating device will have the distance travelled readings corresponding to the vehicle at point A and point B, which it can subtract to obtain the apparent distance travelled according to the odometer, step 32. This can be compared against the verification distance to determine or otherwise verify the accuracy of the odometer, step 33. If the apparent distance travelled and verification distances do not correspond to within a threshold value or tolerance, a discrepancy is determined and the agent advised via a suitable means, such as the interrogation device's I/O interface, step 34. This information can then be used immediately, e.g. to levy a fine, or passed onward (e.g. to a computer system) for subsequent use.

Referring to FIG. 3, in an alternative of this embodiment, the interrogating device does not actually interrogate the electronic distance recorder at the time vehicle passes point A and point B. Rather, it interrogates the electronic distance recorder as it passes point B to obtain the distance travelled reading corresponding to the vehicle at point B. This could be considered the second distance travelled reading, step 31. It then also at that time or afterwards (or optionally even before) interrogates the electronic distance recorder to determine the distance travelled reading at the point the vehicle passed point A. This can be could be considered the first distance travelled reading, step 30. This could be done for example by finding the longitude and latitude coordinates of point A, interrogating the electronic distance recorder's memory to find that longitude and latitude (as determined and stored by the GPS module) when the vehicle passed point A, and then finding the corresponding odometer module distance travelled reading for point A, which will have been stored cross-referenced to the stored GPS position (longitude and latitude) information for point A.

In an alternative, rather than determining the GPS coordinates of point A and finding the distance travelled reading at that point, the interrogation apparatus obtains the GPS coordinates (i.e. location) correlating to the stored distance travelled reading relating to a distance equivalent to the verified distance (reference difference) prior to point B—which is point A. In effect, this is finding the GPS coordinates taken when the vehicle was at point A, being a known reference/verification distance from point B. For example, if point A is 5 km from point B, the distance travelled reading correlating to 5 km before point B (i.e. the distance travelled reading taken when the vehicle is at point A) is found in the distance recorder, and the GPS coordinates correlating to that location obtained. The interrogation apparatus then determines if those GPS coordinates correlate to the known coordinates of point A to within a threshold tolerance. If they do not, then a discrepancy is determined and advised.

In a further alternative of this embodiment, it is not necessary to interrogate the device at the time it passes point B either. Again, the distance travelled reading for point B is found by interrogating the memory to find the distance travelled reading that is correlated to the longitude and latitude of point B. The obtained readings are then compared to the verification distance, as described above, to determine any discrepancies.

In a yet a further alternative to this embodiment, the distance travelled readings are taken by fixed interrogation devices that are placed road-side at points A and B, or remote points A and B but proximate enough in order to take readings as the vehicle passes points A and point B. In this alternative, the road side interrogation devices can communicate with each other and/or communicate with a coordinating device in order to conduct the verification. The verification can be done by determining the distance between point B and point A according to the difference in the odometer readings, and comparing this against the known measured distance between points A and points B. Alternatively, it can be compared against a GPS reading or some other location information taken from the electronic distance recorder.

Alternatively or additionally, the road-side interrogation device will itself have a GPS or other positioning information available, and the verification can take place against the known positions of the interrogation devices according to their own location information.

In an alternative embodiment, the verification distance is obtained from the electronic distance recorder itself. When the interrogation of the electronic distance recorder takes place for points A and point B to obtain the distance travelled, the interrogating device also obtains the corresponding GPS coordinates obtained and stored by the electronic distance recorder for when the vehicle passed points A and B. The distance travelled between points A and B is determined from the GPS coordinates to determine the verification distance. This is compared to the apparent distance travelled from the electronic distance recorder reading, to determine any discrepancies. Alternatively, the verification distance could be determined by obtaining and using distance/position information stored for points A and B as determined by the accelerometer/gyroscope.

In an alternative embodiment, a server or other computer system is in communication with the electronic distance recorder does the interrogation, over, for example, a mobile telephone network. As the vehicle reaches a particular point, trigger or geofence, a first distance travelled reading is taken from the electronic distance recorder (and any other parameters as discussed above). The same interrogation takes place as the vehicle passes a trigger point for point B. The verification can take place in the same way as discussed for any other of the embodiments. For, example the apparent distance as determined from the electronic distance recorder readings can be compared against the GPS readings or known distances between the two points from maps or other technologies.

In any of the above embodiments, the checking can be done retrospectively using stored information in the distance recorder.

In any of the embodiments, camera, video or other recording technology could be used to provide proof of the vehicle under investigation.

To enable verification to be used as evidence against tampering or inaccuracies of distance recorders, it is desirable that the verifications can be corroborated. To assist, a camera is provided in the interrogation apparatus to capture images (still or video) of the vehicles (including licence plate/registration number) which have distance recorders being verified. The image can be correlated against the verification information, optionally using Automatic Licence Plate Recognition (APLR). The security module also enables the authenticity of data to be verified (namely, has it come from the distance recorder in question), its integrity to be verified (namely, has the data been tampered with) and to provide privacy of data to prevent third parties obtaining the information.

1. A method of checking a vehicle's electronic distance recorder by an independent party comprising the independent party using one or more devices to:
obtain/receive two distance or location readings (or a distance and location reading) from the electronic distance recorder for two vehicle locations, the distance location/readings being obtained by the electronic distance recorder;
determine an apparent distance travelled between the two vehicle locations using the distance/location readings; and
compare the apparent distance travelled with a verification distance between the two locations to identify any discrepancies in the electronic distance recorder, the verification distance being determined independently from the electronic distance recorder.

2. A method according to claim 1 further comprising obtaining one or more images of the vehicle.

3. A method according to claim 1 further comprising obtaining/receiving a time reading.

4. A method according to claim 1 further comprising comparing the time and/or location reading(s) to a reference to identify discrepancies.

5. A system for checking a vehicle's electronic distance recorder by an independent party comprising an interrogation apparatus with a receiver and processor configured to:
obtain/receive via the receiver two distance or location readings (or a distance and location reading) from the electronic distance recorder for two vehicle locations;
determine in the processor an apparent distance travelled between the two vehicle locations; and
compare in the/another processor the apparent distance travelled with a verification distance between the two locations to identify any discrepancies in the electronic distance recorder.

6. (canceled)

7. A system according to claim 5 further comprising two or more interrogation devices that form the interrogation apparatus.

8. A system according to claim 5 further comprising an electronic distance recorder in a vehicle.

9. A system according to claim 5 further comprising a proximate or remote server or computer system in communication with the interrogation device(s).

10. A system according to claim 9 wherein the computer system or server form part or all of the interrogation apparatus and is proximate or remote to the locations.

11. A system according to claim 9 wherein the interrogation device comprises a data capture device and a remote processor (optionally in a computer system or server), wherein the data capture device transmits captured data to the remote processor.

12. A system according to claim 5 wherein the interrogation devices are in communication with each other.

13. (canceled)

14. An interrogation apparatus with a receiver for checking a vehicle's electronic distance recorder by an independent party, the apparatus configured to:
obtain/receive via the receiver two distance or location readings (or a distance and location reading) from the electronic distance recorder for two vehicle locations,
determine in a processor or transmit via a transceiver the information to a processor to determine an apparent distance travelled between the two vehicle locations, and
compare in the processor or transmit via the transceiver the information to a processor to compare the apparent distance travelled with a verification distance between the two locations to identify any discrepancies in the electronic distance recorder.

15. (canceled)

16. An interrogation apparatus according to claim 14 wherein each distance or location reading is obtained by interrogating the electronic distance recorder at the respective vehicle location.

17. An interrogation apparatus according to claim 14 wherein each distance or location reading is obtained remotely by interrogating the electronic distance recorder at one or neither of the locations.

18. An interrogation apparatus according to claim 14 wherein one or both of the distance or location readings can be obtained at the time the vehicle is at the respective location, or one or both of the distance or location readings can be obtained retrospectively at a time when the vehicle is not at the respective location.

19. An interrogation apparatus according to claim 14 wherein the distance or location readings are derived from output from an internal odometer, speed signal, GPS and/or accelerometer/gyroscope.

20. An interrogation apparatus according to claim 14 wherein the verification distance can be obtained from parameter readings obtained from the electronic distance recorder corresponding to the two vehicle locations.

21. An interrogation apparatus according to claim 14 wherein the verification distance can be determined using an external measure.

22. An interrogation apparatus according to claim 14 wherein the electronic distance recorder is interrogated at the respective vehicle location using an interrogation apparatus.

23. An interrogation apparatus according claim 22 wherein the interrogation apparatus can be proximate the vehicle location.

24. An interrogation apparatus according to claim 22 wherein the interrogation apparatus can be stationed proximate the vehicle location.

25. An interrogation apparatus according to claim 22 wherein the interrogation apparatus can be transported to a position proximate the vehicle location.

26. An apparatus according to claim 22 wherein the interrogation apparatus can be stationed or transported to a location remote to the first and/or second locations.

27. An interrogation apparatus according to claim 14 further comprising an image capture device for capturing an image of the vehicle and/or licence/registration plate for use with ALPR (automatic licence plate recognition) technology.

28.-30. (canceled)
